(19) United States
(12) Patent Application Publication
(10) Pub. No.: US 2010/0005212 A1
(43) Pub. Date: Jan. 7, 2010

(54) PROVIDING A VARIABLE FRAME FORMAT PROTOCOL IN A CASCADE INTERCONNECTED MEMORY SYSTEM

(75) Inventors: Kevin C. Gower, LaGrangeville, NY (US); Warren E. Maule, Cedar Park, TX (US); Michael R. Trombley, Cary, NC (US); Gary A. Van Huben, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/166,244

(22) Filed: Jul. 1, 2008

(51) Int. Cl. G06F 13/28

(52) U.S. Cl. 710/308

(57) ABSTRACT

Systems and methods for providing a variable frame format protocol in a cascade interconnected memory system. The systems include a memory hub device that utilizes a first bus interface to communicate on a high-speed bus. The hub device also includes frame decode logic for translating variable format frames received via the first bus interface into memory device commands and data. The translating includes identifying write data headers and associated write data for self-registering write to data buffer commands.

This invention was made with Government support under Agreement No. HR0011-07-9-0002 awarded by DARPA. The Government has certain rights in the invention.

### BACKGROUND

This invention relates generally to computer memory systems, and more particularly to providing a variable frame format protocol in a cascade interconnected memory system.

Contemporary high performance computing main memory systems are generally composed of one or more dynamic random access memory (DRAM) devices, which are connected to one or more processors via one or more memory control elements. Overall computer system performance is affected by each of the key elements of the computer structure, including the performance/structure of the processor(s), any memory cache(s), the input/output (I/O) subsystem(s), the efficiency of the memory control function(s), the main memory device(s), and the type and structure of the memory interconnect interface(s).

Extensive research and development efforts are invested by the industry, on an ongoing basis, to create improved and/or innovative solutions to maximizing overall system performance and density by improving the memory system/subsystem design and/or structure. High-availability systems present further challenges as related to overall system reliability due to customer expectations that new computer systems will markedly surpass existing systems in regard to mean-time-between-failure (MTBF), in addition to offering additional functions, increased performance, increased storage, lower operating costs, etc. Other frequent customer requirements further exacerbate the memory system design challenges, and include such items as ease of upgrade and reduced system environmental impact (such as space, power and cooling).

### SUMMARY

An exemplary embodiment is a memory hub device that includes a first bus interface for communicating with a high-speed bus. The hub device also includes frame decode logic for translating variable format frames received via the first bus interface into memory device commands and data. The translating includes identifying write data headers and associated write data for self-registering write to data buffer commands.

Another exemplary embodiment is a method for providing a variable frame format protocol in a cascade interconnected memory system. The method includes receiving frames of varying formats on a high-speed bus. The receiving is at a hub device in a cascade interconnected memory system, and each frame includes a frame type indicator and one or more write data bits. Placement of the write data bits in the frames is determined based on the frame type indicator. The contents of the write data bits are monitored. A write data header for a self-registering write to data buffer command is identified in the write data bits. The write data header specifies a length of associated write data and a target hub device identifier. The associated write data is identified in the write data bits based on the write data header. The associated write data is written to a write data buffer at the hub device if the hub device is the target device.

A further exemplary embodiment is a memory controller that includes a first bus interface for communicating with one or more hub devices in a cascade interconnect memory system via a high-speed bus. The memory controller also includes frame encoding logic for generating variable format frames for transmission to the hub devices. The generated frames include frame type indicators for specifying locations of write data bits in the frames. The generated frames also include write data headers and associated write data for self-registering write to data buffer commands. The write data header and associated write are located in the write data bits.

A still further exemplary embodiment is a design structure tangibly embodied in a machine readable format for designing, manufacturing, or testing an integrated circuit. The design structure includes a hub device including a first bus interface to communicate on a high-speed bus and frame decode logic to translate frames received via the first bus interface into memory device commands and data. The translating includes identifying write data headers and associated write data for self-registering write to data buffer commands.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

Referring now to the drawings wherein like elements are numbered alike in the several FIGURES:

FIG. 1 depicts a cascade interconnected memory system for providing a variable frame format protocol that may be implemented by exemplary embodiments;

FIG. 2 depicts communication devices cascade interconnected via high-speed upstream and downstream links that may be implemented by exemplary embodiments;

FIG. 3 depicts a memory hub device coupled with multiple ranks of memory devices that may be implemented by exemplary embodiments;

FIG. 4 depicts examples of downstream frame formats that may be implemented by exemplary embodiments;

FIG. 5 depicts examples of block formats for downstream transfers that may be implemented by exemplary embodiments;

FIG. 6 depicts an example write data header that may be utilized to implement self-registering write data in an exemplary embodiment;

FIG. 7 depicts example write data mappings that may be implemented by an exemplary embodiment for thirty-six byte and seventy-two byte data writes;

FIG. 8 depicts an example configuration register write data mapping that may be implemented by an exemplary embodiment;

FIG. 9 depicts an example of an upstream transfer frame format that may be implemented by exemplary embodiments;

FIG. 10 depicts an example read data mapping that may be implemented by an exemplary embodiment for seventy-two byte data reads;

FIG. 11 depicts an example configuration register read data mapping that may be implemented by an exemplary embodiment;

FIG. 12 depicts a process flow for providing a variable frame format protocol that may be implemented by exemplary embodiments of the present invention;

FIG. 13 depicts maintenance commands that may be implemented by an exemplary embodiment of the present invention; and

FIG. 14 is a flow diagram of a design process used in semiconductor design, manufacture and/or test.

### DETAILED DESCRIPTION

An exemplary embodiment of the present invention pertains to a memory system where one or more memory hub devices are cascaded (or daisy chained) together and each device includes up to two memory ports interfacing either directly with DRAM devices or indirectly through registered clock drivers. An exemplary embodiment incorporates a packet based protocol which permits data and command information to be transmitted in both directions (up and down the channel) on a high-speed link. The protocol employs a variable length frame format which enables a plurality of DRAM speeds to synchronize to a constant channel frequency while maximizing memory bandwidth and minimizing latency.

An exemplary embodiment is a high-speed link protocol including a plurality of data packets known as blocks, which are dynamically organized into frames. The link (or channel) includes a downstream bus made up of a plurality of data lanes (or wires) and an upstream bus with similar data lanes. The downstream frames include a variable number of block transfers, which is a function of the configurable memory channel to memory device clock ratio. An exemplary embodiment supports a plurality of memory channel to memory clock ratios, known as the gear ratios. Data is transmitted serially over the high-speed link, and every four transfers denotes a block. For the 4:1 gear ratio, eight transfers, (two blocks) are used; for the 5:1 gear, eight and twelve transfers are used alternatively on even and odd clock cycles. In the 6:1 gear, twelve transfers are used; and for the 8:1 gear, sixteen transfer frames are used. In an exemplary embodiment, blocks are transmitted in a sequential order (3,2,1,0 or 2,1,0 or 1,0) within each frame such that block zero is always issued last.

The blocks contain a mixture of data, command, and address information. In an exemplary embodiment, blocks three and two are always used for data, otherwise they are empty. Blocks one and zero may contain commands, data, or nothing. Frame type indicators inserted in block zero allow the controller to dynamically construct frames comprising all data, or a mixture of data with one command, or data with two commands. This aspect of the exemplary embodiments achieves increased store bandwidth without the inefficiency of dedicated command and data busses. To further improve store bandwidth, data associated with a second data transfer can be appended to data for a first data transfer such that the data bits are seamlessly merged within the same frame (referred to herein as self-registering write to data buffer commands). Exemplary embodiments permit thirty-six or seventy-two byte data transfers. A byte of header information is utilized by the self-registering write to data buffer commands to denote size, target hub device, and target write data buffer of the current data packet.

A further aspect of exemplary embodiments is the use of packeted read and write commands which permit an extra byte of storage to be inserted into a block position normally allocated to command information. The reduction in command bits arises from the implied usage of a previous opened memory bank, thereby eliminating the need to transmit chip, rank and bank identification bits. The memory controller is permitted to transmit a plurality of commands to two open banks simultaneously by targeting packet read/write commands in block one to a first bank while targeting packet commands in block two to a second bank.

An exemplary embodiment supports a memory channel having a plurality of hub devices where downstream commands are transmitted to every hub device. Each hub device supports up to two memory ports with up to eight ranks on each port. The protocol comprises hub device identification bits which allow each hub device to snoop the channel and service frames intended for it. A special broadcast decode allows the memory controller to signal all hub devices within a single transmission.

An exemplary embodiment of the downstream protocol includes memory access and service commands including, but not limited to, bank activate, read, write, packet read, packet write, refresh, mode register set, pre-charge, error acknowledgement, maintenance, and hub internal register access. It also includes CKE control command to allow the memory controller to perform direct manipulation of the DRAM CKE signals for entry/exit of power down and self-timed refresh operations. Maintenance commands include BIST, memory interface calibration, register clock driver control, DRAM asynchronous reset, and channel latency configuration.

An exemplary embodiment further includes a similar block and frame format to deliver memory read data on an upstream bus in the channel back to the memory controller. The protocol enlists the use of a fixed frame format where each frame is made up of two nine byte blocks. Two frame transfers return thirty-six bytes of data while four frame transfers return seventy-two bytes. All data transfers are protected by a cyclic redundancy code (CRC) which provides protection up to a persistent lane failure. The CRC code protects the data packets which themselves contain embedded ECC bits to detect (and correct) DRAM fails.

While the upstream bus is idle, the last hub device in the channel sends a consistent pattern which is scrambled by the memory channel logic. In order to maximize performance, memory read data is always returned as quickly as possible. In a 4:1 gear ratio, this results in gapless transfers of consecutive memory reads. However, in 5:1, 6:1 and 8:1 gears, the DRAMs may not be able to supply data at a sufficient rate to satisfy the channel speed, therefore the protocol supports the insertion of idle blocks.

Hub device internal registers may be accessed through the use of write and read configuration commands which permit the memory controller to load and access the registers as if it were a DRAM access. This consistent usage paradigm allows the memory controller to pack configuration data into downstream frames in concert with commands. Up to four sets of configuration data may be packed into a single data buffer for subsequent transfer to configuration registers. Internal register reads utilize the same upstream frame protocol and latency as memory data thereby allowing configuration reads to be scheduled along with DRAM accesses.

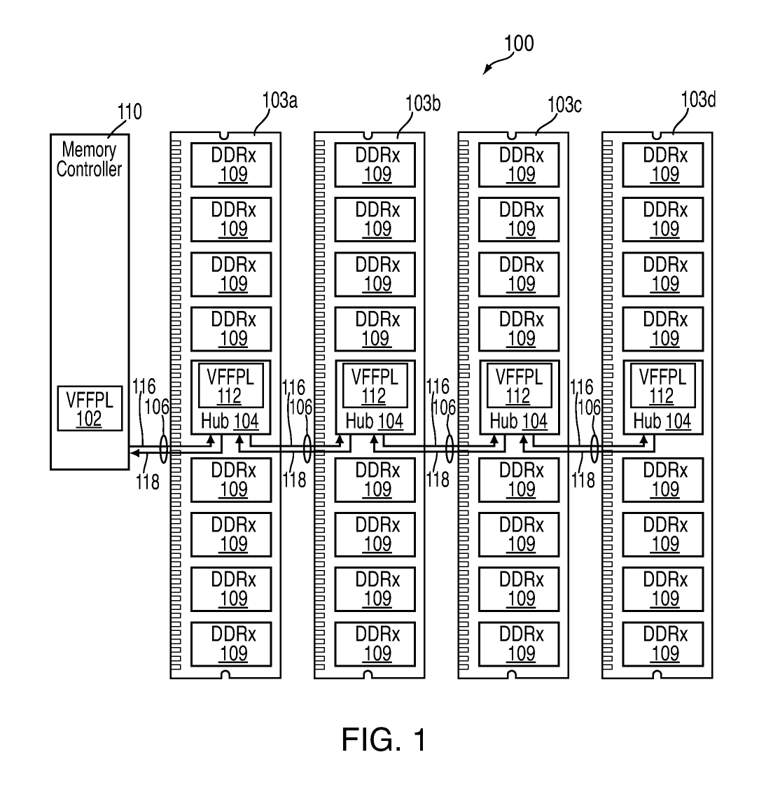

FIG. 1 depicts a cascade interconnected memory system for providing a variable frame format protocol that may be implemented by exemplary embodiments. FIG. 1 depicts an example of a memory system 100 that includes fully buffered dual in-line memory modules (DIMMs) communicating via a high-speed channel 106. In an exemplary embodiment, the memory system 100 is incorporated in a host processing system as main memory for the processing system. The memory system 100 includes a number of DIMMs 103a, 103b, 103c and 103d with memory hub devices 104 communicating via the high-speed channel 106. The high-speed channel depicted in FIG. 1 is a cascade-interconnected channel made up of a differential unidirectional upstream bus 118 and a differential unidirectional downstream bus 116. The DIMMs 103a-103d can include multiple memory devices 109, which may be double data rate (DDR) dynamic random access memory (DRAM) devices, as well as other components known in the art, e.g., resistors, capacitors, etc. The memory devices 109 are also referred to as DRAM 109 or DDRx 109, as any version of DDR may be included on the DIMMs 103a-103d, e.g., DDR2, DDR3, DDR4, etc. DIMM 103a, as well as DIMMs 103b-d may be dual sided, having memory devices 109 on both sides of the DIMMs 103. A memory controller 110 directly interfaces with DIMM 103a, sending commands, address and data values via the channel 106 that may target any of the DIMMs 103a-103d. In one embodiment, if a DIMM 103 receives a frame having a command that is not intended for it, the DIMM 103 redrives the command to the next DIMM 103 in the daisy chain (e.g., DIMM 103a redrives to DIMM 103b, DIMM 103b redrives to DIMM 103c, etc.). In another embodiment, a DIMM 103 does not check the commands in the frames before redriving the frames downstream to save on command decode latency to downstream DIMMs 103. In an embodiment described herein, the command decode logic (e.g., to detect commands, self-registering write to data buffer commands and associated data) is executed by variable frame format protocol logic (VFFPL) 112 located in the hub device 104 at each DIMM 103. In this embodiment, the command decode and the redrive to the downstream DIMM 103 occur in parallel. The commands, address and data values are formatted as frames and serialized for transmission at a high data rate, e.g., stepped up in data rate (e.g., by a factor of 4, 6, etc.).

The hub devices 104 on the DIMMs 103 receive commands via a bus interface to the channel 106. The interface on the hub device 104 includes, among other components, a receiver and a transmitter. In an exemplary embodiment, a hub device 104 includes both an upstream bus interface for communicating with an upstream hub device 104 or memory controller 110 via the channel 106 and a downstream interface for communicating with a downstream hub device 104 via the channel 106.

As depicted in the embodiment shown in FIG. 1, the memory controller 110 includes variable frame format protocol logic (VFFPL) 102 to generate the frames (e.g., to generate/encode frames that include commands, self-registering write to data buffer commands and associated data) transmitted to the DIMMs 103 via the downstream bus 106 on the channel 106.

Although only a single memory channel 106 is shown in FIG. 1 connecting the memory controller 110 to a single memory device hub 104, systems produced with these modules may include more than one discrete memory channel 106 from the memory controller 110, with each of the memory channels 106 operated singly (when a single channel is populated with modules) or in parallel (when two or more channels are populated with modules) to achieve the desired system functionality and/or performance. Moreover, any number of lanes can be included in the channel 106. For example, the downstream bus 116 can include thirteen bit lanes, two spare lanes and a clock lane, while the upstream bus 118 may include twenty bit lanes, two spare lanes and a clock lane.

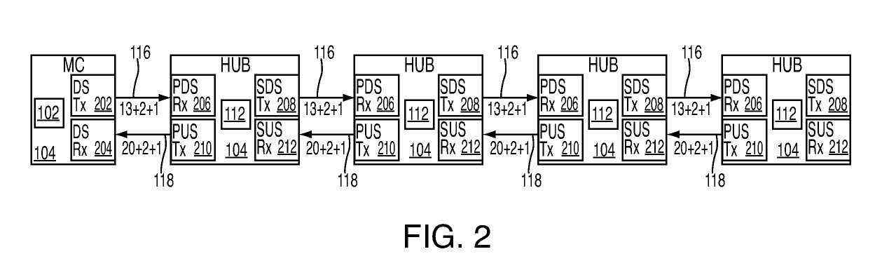

FIG. 2 depicts an exemplary embodiment of how the hub devices 104 are cascade interconnected via high-speed upstream and downstream links. Memory hub device 104 contains buffer elements in the downstream and upstream directions so that the flow of data can be averaged and optimized across the high-speed memory channel 106 to the memory controller 110. Flow control from the memory controller 110 in the downstream direction is handled by downstream transmission logic (DS Tx) 202, while upstream data is received by upstream receive logic (US Rx) 204 as depicted in FIG. 2. The DS Tx 202 drives signals on the downstream segments (referred to collectively herein as the downstream bus 116) to a primary downstream receiver (PDS Rx) 206 of memory hub device 104. The commands or data received at the PDS Rx 206 may target a different memory hub device 104 and thus in an exemplary embodiment all signals received are redriven downstream via a secondary downstream transmitter (SDS Tx) 208. The commands and data are processed locally at the targeted memory hub device 104. The memory hub device 104 may analyze the commands being redriven to determine the amount of potential data that will be received on the upstream segments (referred to collectively herein as the upstream bus 118) for timing purposes in response to the commands. Similarly, to send responses upstream, the memory hub device 104 drives upstream communication via a primary upstream transmitter (PUS Tx) 210 which may originate locally or be redriven from data received at a secondary upstream receiver (SUS Rx) 212.

In an exemplary embodiment, the memory system uses cascaded clocking to send clocks between the memory controller 110 and memory hub devices 104, as well as to the memory devices of the attached memory modules.

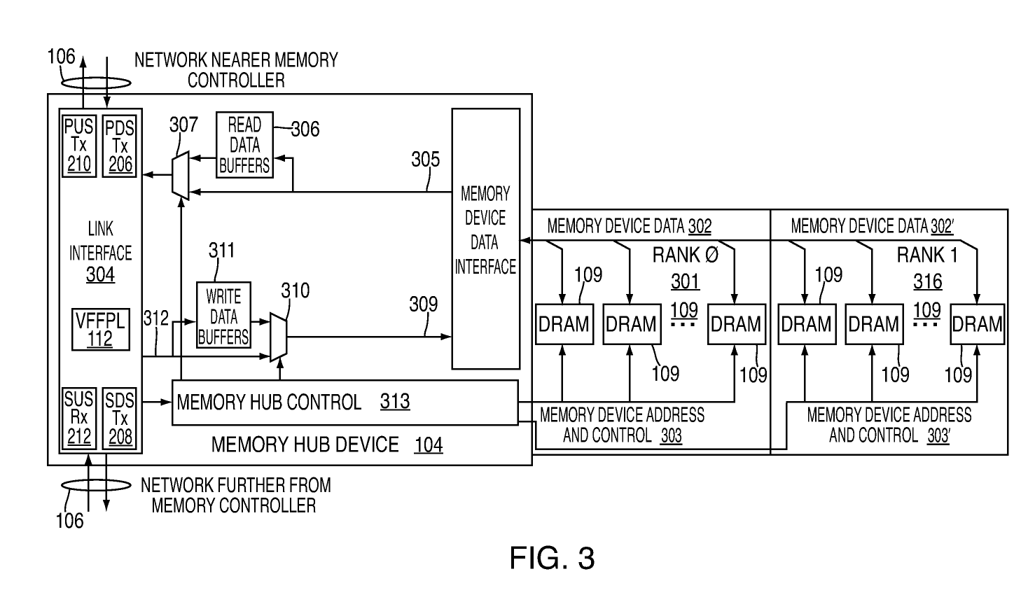

FIG. 3 depicts a memory hub device coupled with multiple ranks of memory devices that may be implemented by exemplary embodiments. The memory devices 109 may be organized as multiple ranks as shown in FIG. 3. Link interface 304 provides means to re-synchronize, translate and re-drive high-speed memory access information to associated memory devices 109 and/or to re-drive the information downstream on memory channel 106 as applicable based on the memory system protocol. The memory hub device 104 supports multiple ranks (e.g., rank 0 301 and rank 1 316) of memory devices 109 as separate groupings of memory devices using a common hub. The link interface 304 includes PDS Rx 206, SDS Tx 208, PUS Tx 210, and SUS Rx 212 to support driving, receiving, sparing, and repair of link segments (e.g. wires) in upstream and downstream directions on the memory channel 106. Data and clock link segments are received by the link interface 304 from an upstream memory hub device 104 or from memory controller 110 (directly or via an upstream memory hub device 104) via the memory channel 106. Memory device data interface 315 manages a technology-specific data interface with the memory devices 109 and controls bi-directional memory device data buses 302 302′.

The memory hub control 313 responds to access request frames by responsively driving the memory device technology-specific address and control bus 303 (for memory devices in rank 0 301) or address and control bus 303′ (for memory devices in rank 1 316) and directing read data flow 307 and write data flow 310 selectors. The link interface 304 decodes the frames (e.g., using frame decode logic in the VFFPL 112) and directs the address and command information directed to the memory hub device 104 to the memory hub control 313. Memory write data from the link interface 304 can be temporarily stored in the write data buffer 311 or directly driven to the memory devices 109 via the write data flow selector 310 and internal bus 312, and then sent via internal bus 309 and memory device data interface 315 to memory device data bus 302. Memory read data from memory device(s) 109 can be queued in the read data buffer 306 or directly transferred to the link interface 304 via internal bus 305 and read data selector 307, to be transmitted on upstream link segments of the channel 106 as a read data frame or upstream frame. In an exemplary embodiment, the read data buffer 306 is 4×72-bits wide×8 transfers deep, and the write data buffer 311 is 16×72-bits wide×8 transfers deep (8 per port 106). The read data buffer 306 and the write data buffers 311 can be further partitioned on a port basis, such as separate buffers for each of the ports.

In an exemplary embodiment, the hub device 104 includes sixteen addressable write data buffers 311, eight for each of the two memory ports. Each write data buffer 311 is capable of storing up to seventy-two bytes of write data. Both seventy-two byte and thirty-six byte write data blocks consume one buffer each. Write and packet write commands directed to a hub device 104 include a write buffer identification field used with rank identification bits to determine port, rank and memory device targets for the write data. In an exemplary embodiment, data associated with the self-registering write data buffer commands are written to the write data buffers 311.

The read data buffer 306 and the write data buffer 311 may also be accessed via a service interface. Additional buffering (not depicted) can be included in the memory hub device 104, e.g., in the link interface 304.

The hub device 104 depicted in FIG. 3 includes two ports that are independently operable for interfacing with the memory devices 109. As depicted in FIG. 3, a first port interfaces to memory device address and control bus 303 and memory device data bus 302, and a second port interfaces to memory device address and control bus 303′ and memory device data bus 302′. In an exemplary embodiment, each port provides seventy-two data query (DQ) signals for reading from and writing to the memory devices 109.

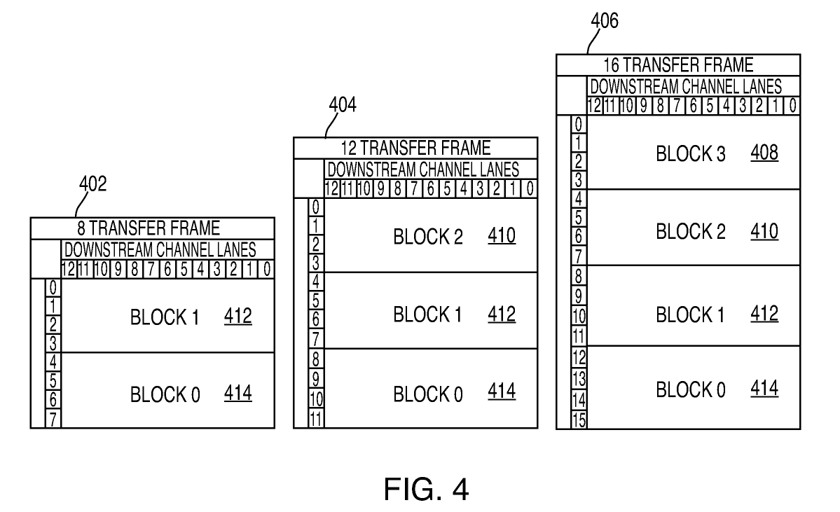

FIG. 4 depicts examples of downstream frame formats that may be implemented by exemplary embodiments. Commands and data values communicated on the channel 106 may be formatted as frames and serialized for transmission at a high data rate, e.g., stepped up in data rate by a factor of 4, 5, 6, 8, etc.; thus, transmission of commands, address and data values is also generically referred to as “data” or “high-speed data” for transfers on the channel 106. In contrast, memory bus communication (e.g., memory device data busses 302 302′ and memory device address and control busses 303 303′) is referred to as “lower-speed”, since they operate at a reduced ratio of the channel speed. In order to support multiple clock ratios, frames are further divided into units called “blocks”. In an exemplary embodiment, three different size frames are used in varying combinations to provide a mix of commands and data for downstream communication. These frames are depicted in FIG. 4 as 8-transfer frame 402, 12-transfer frame 404, and 16-transfer frame 506. The number of transfers in a downstream frame is a function of the configurable memory channel to DRAM clock ratio (M:N). For instance, if the M:N ratio is 4:1, then the 8-transfer frame 402 can be used. However, if the ratio is 5:1, the number of transfers alternates between the 8-transfer frame 402 and the 12-transfer frame 404 on even and odd memory clock cycles. In the 6:1 case, the 12-transfer frame 404 can always be used. In the 8:1 case, the 16-transfer frame 406 may always be used. The frames 402, 404, and 406 are further divided into 4 transfer blocks that are numbered block 3 408, block 2 410, block 1 412 and block 0 414. When arranged in descending order, block 0 414 is issued last within each frame 402-406. While the example depicted in FIG. 4 depicts each transfer as including 13 downstream lanes, it will be understood that a different number of downstream lanes can be utilized within the scope of the invention.

In each block 0 414-block 3 408, bits that are not used in defining commands, frame type (FT) information or for error checking can be used to transfer write data. Write data are sent as a continuous stream of nibbles within the blocks of the frames 402-406. The first two nibbles of a write data stream are called a “header”, which indicates that a data transfer (e.g,. a write to data buffer command) is beginning and also includes a chip identifier for a target memory hub device 104 and a write data buffer identifier for a target write data buffer 311 on the target memory hub device 104.

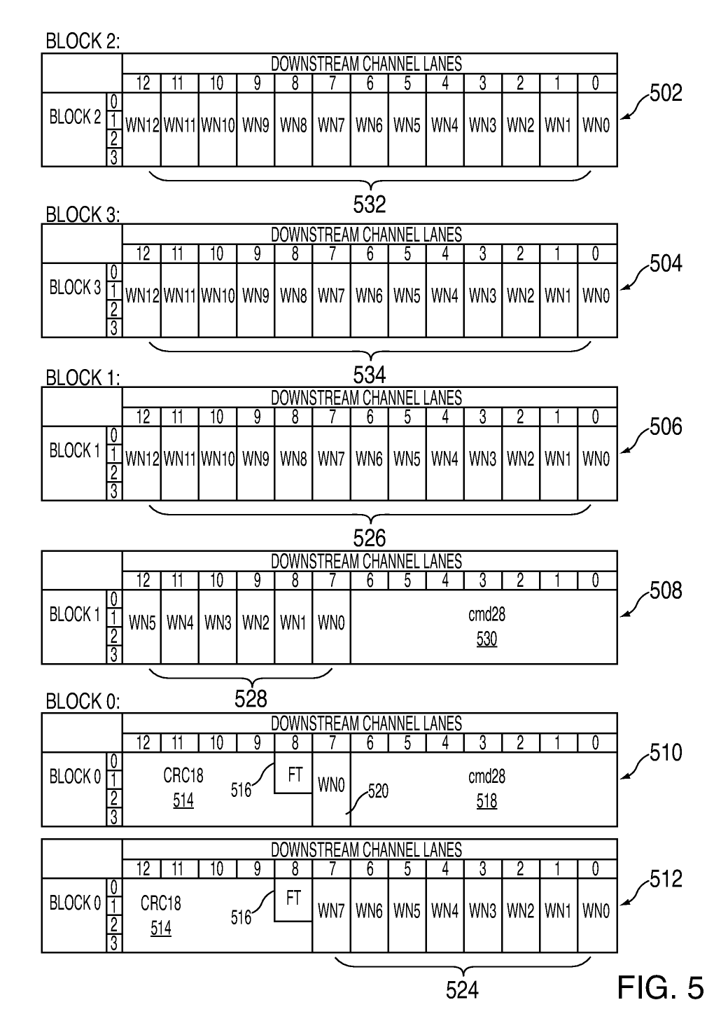

The memory hub device 104 and the memory controller 110 may support multiple block types. Type 2 and 3 blocks contain only write data (block 2 410 and block 3 408) and type 0 and 1 blocks contain write data plus an optional command (block 0 414 and block 1 412). Type 0 blocks also contain an 18-bit cyclic redundancy check (CRC) to validate the integrity of other data in the same frame. Transfer numbers correspond to relative clock cycles on the high-speed memory channel 106 when the corresponding data would be present. Additional details of the contents of the blocks are depicted in FIG. 5.

FIG. 5 depicts examples of block formats for downstream transfers that may be implemented by exemplary embodiments. Block formats 502 and 504 for blocks 2 410 and 3 408 include write data nibbles 532 and 534 respectfully to accommodate larger amounts of write data. Block 0 414 and block 1 412 can support multiple formats. For example, block 0 414 may be formatted as block format 510 or 512, and block 1 412 can be formatted as block format 506 or 508. Additionally, portions or all of block 0 414-block 3 408 can be empty/null/zero.

Block formats 510 and 512 both include an 18-bit CRC 514 and 2-bit FT field 516. The FT field 516 indicates whether commands are located in block 0 414 (indicated, for example, by a value of “01”), block 1 412 (indicated, for example, by a value of “10”), neither (indicated, for example, by a value of “00”), or both (indicated, for example, by a value of “11”). Block format 510 may also include a 28-bit command field 518 and a write data nibble 520. The write data nibble 520 includes 4-its of write data. If a packet command is encoded in the command field 518, an additional 2 nibbles of write data may be included as part of in the command field 518. Block format 512 includes a group of up to 8 write data nibbles 524 and no command field.

Block formats 506 and 508 for block 1 412 can contain write data and/or a command field or nothing. For example, block format 506 includes a group of up to 13 write data nibbles 526, whereas block format 508 includes a group of up to 6 write data nibbles 528 and a second 28-bit command field 530. Thus, a frame that includes block formats 510 and 508 can send two commands in the same frame. If a packet command is encoded in the command field 530, an additional 2 nibbles of write data may be included as part of in the command field 530.

The commands that the memory controller 110 optionally inserts into the command fields 518 and 530 control the memory activity through the memory hub device 104 in a deterministic manner. The commands are generally of two classes, those that map directly to memory device commands and those used to configure and control the memory hub device 104 device itself. The command fields 518 and 530 can include a variety of JEDEC standard memory device commands, such as DDR3 commands for bank activation, mode register set, write, read, and refresh. Other commands may be non-JEDEC standard commands directed to perform other memory hub device 104 specific commands. Examples of such commands include packet read, packet write, maintenance commands, clock configuration and control, error acknowledgement, read configuration information, and write configuration information. The commands can target a single memory hub device 104 or multiple memory hub devices 104 as broadcast commands.

In an exemplary embodiment, write data associated with a write to data buffer command is delivered to the hub devices 104 on the downstream link (or downstream bus 116) of the memory channel 106. Blocks of data to be written to the write data buffer can contain either thirty-six or seventy-two bytes. They are made up of continuous streams of write data nibbles immediately following two, four bit headers with the downstream frames. Once a write data transfer is started by the host memory controller 110, each available write nibble within all downstream frames must contain the next consecutive write data nibble. Only commands, frame type bits and CRC bits may interrupt the flow of write data nibbles once the transfer is started. Each write data nibble is loaded into a hub device 104 write data buffer 311 addressed by the write data header. New write data blocks (e.g., self-registering write to data buffer commands) may begin immediately after a previously started write data block completes or in any following write data nibble. Alternatively, the start of a non-consecutive write to data buffer command may be limited to the least significant write data nibble within any following four transfer downstream frame block. This alternate embodiment is simpler because the hub device 104 does not need to decode write data headers in other, non-starting locations.

As described previously, in an exemplary embodiment, the hub device 104 includes sixteen addressable write data buffers 311, eight for each of the two memory ports. Each write data buffer 311 is capable of storing up to seventy-two bytes of write data. Both seventy-two byte and thirty-six byte write data blocks consume one write data buffer 311 each. Write and packet write commands directed to a hub device 104 include a write buffer identification field (wb(2:0)), used with the port decode of the rank (3:0) bits, to select the memory devices that are the target of the write data.

The memory controller 110 keeps track of the hub device 104 write data buffers 311 to ensure that data is available on time for a write command (e.g., received as command 518 in block 0 when the FT is set to “01”) and that it is not overwritten before it is safely stored in the memory devices 109. In order to ensure that write data is available for a given write command, the final nibble of a write data block must be received no later than the hub device write command (or write configuration command), to write data latency after the same frame as the write, or packet write, command that uses the write data block. In order to ensure that write data is not over-written prematurely, a write data block to a given buffer may be started no sooner than the hub device write command (or write configuration command), to write data latency plus the burst length divided by two after the frame that included the previous write or packet write command that referenced the write data buffer 311.

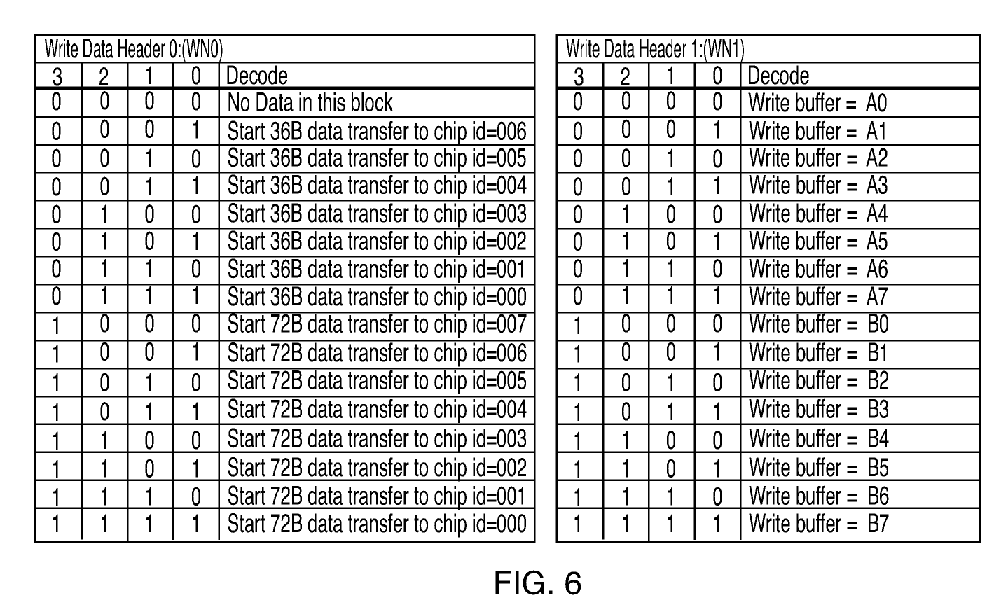

FIG. 6 depicts an example write data header that may be utilized to implement self-registering write to data buffer commands in an exemplary embodiment. The two nibble write data header includes the target hub device 104. The target hub device 104 is identified by a unique “chip id” which is assigned to the hub devices 104 during system configuration. In addition, the write data header includes a target data port, the length of the write data, and a target write data buffer 311. As depicted in FIG. 6, write data header 0 (in WNO) indicates the target hub device and the length of the write data block; and write data header 1 (in WN1) indicates the target data port and the target write data buffer for the data.

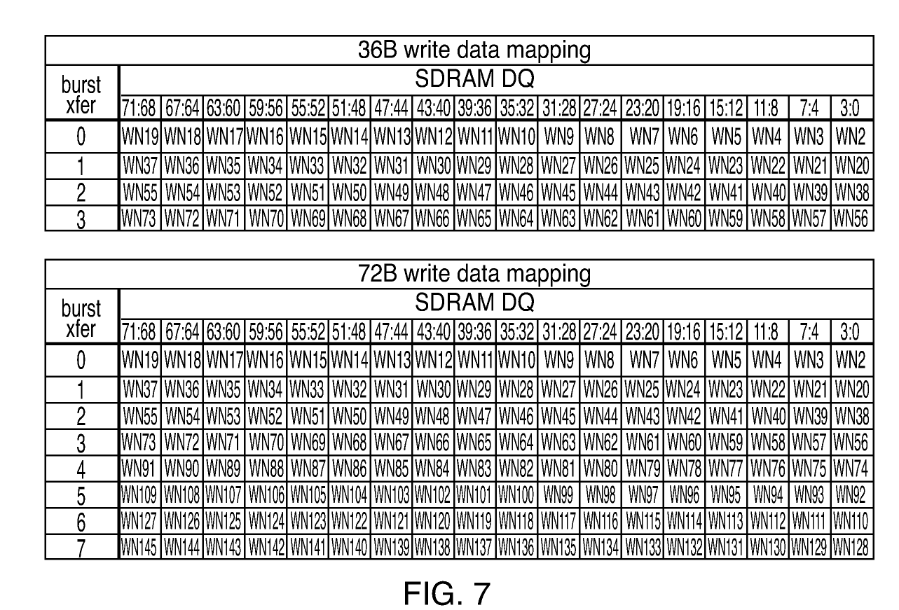

FIG. 7 depicts example write data mappings that may be implemented by an exemplary embodiment for thirty-six byte and seventy-two byte data writes. During write and packet write command execution, the hub device 104 unloads its addressed write data buffer 311 and maps the write data nibbles from the thirty-six byte and seventy-two byte transfers to the memory device DQ signals according to the format in table FIG. 7. Note, that since write nibbles zero and one (WN0, WN1) are used for the write data header, write nibble two (WN2) is the least significant nibble that maps to the DDRx memory data.

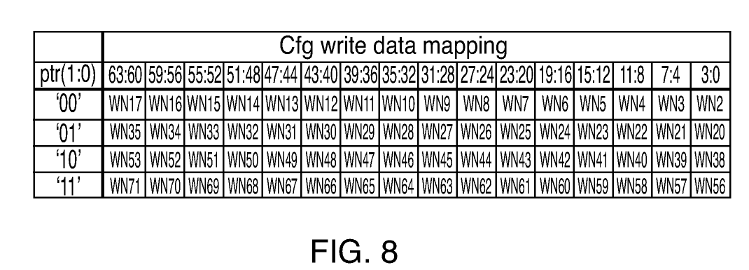

FIG. 8 depicts an example configuration register write data mapping that may be implemented by an exemplary embodiment. During the configuration register write commands, the hub device 104 unloads its addressed write data buffer 311 and loads it into the referenced configuration register according the format in the table in FIG. 8. The pointer field (ptr(1:0)) allows selection of a subset of the writer buffer bits. This allows multiple configuration write commands per write data buffer load command.

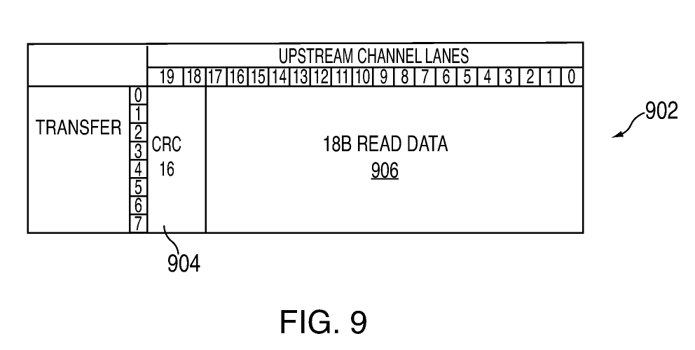

FIG. 9 depicts an example of an upstream transfer frame format 902 that may be implemented by exemplary embodiments. In an exemplary embodiment, upstream data channel data sent on the upstream bus 118 utilize a single type of frame as depicted in FIG. 9. Upstream frames are used to return memory read data and hub device register information to the memory controller 110. Hub device registers contain all readable fields from within the hub device 104 including configuration, status, fault isolation, trace array contents, ECID, temperature and voltage monitors, etc. In an exemplary embodiment, upstream frames always have eight transfers, including eighteen bytes of payload information (e.g. read data 906) and use sixteen CRC bits (e.g., in a CRC16 field 904) for error detection. Each vertical data channel lane in FIG. 9 below includes data bits from the same DDRx DQ nibbles. This allows both upstream channel CRC and read data ECC to detect lane failures. In an exemplary embodiment, to provide maximum readability, the host memory controller 110 constructs its own data ECC and error handling routines to leverage this overlapping information.

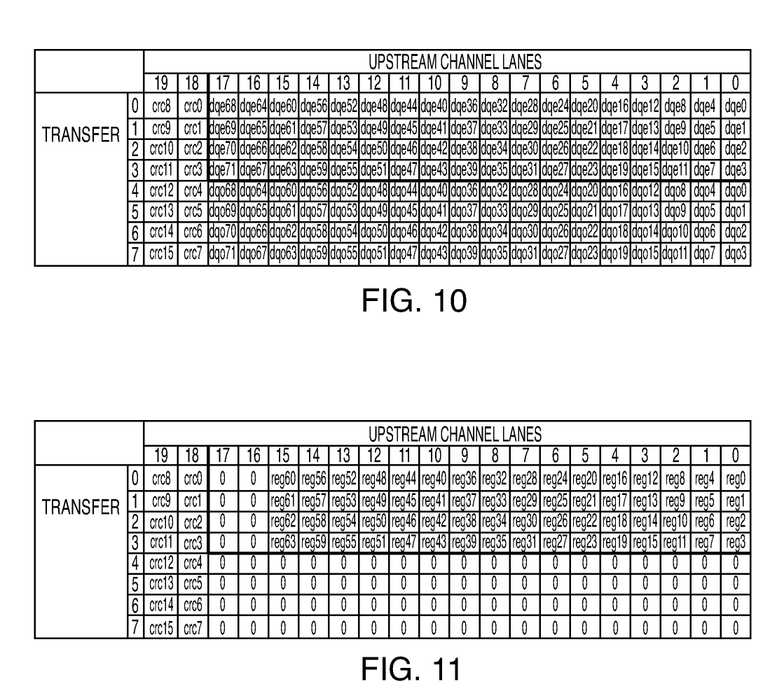

FIG. 10 depicts an example read data mapping that may be implemented by an exemplary embodiment for seventy-two byte data reads. FIG. 10 depicts the mapping of memory DQ signals zero through seventy-one, even and odd transfers, onto each of the bits in the upstream read data frame.

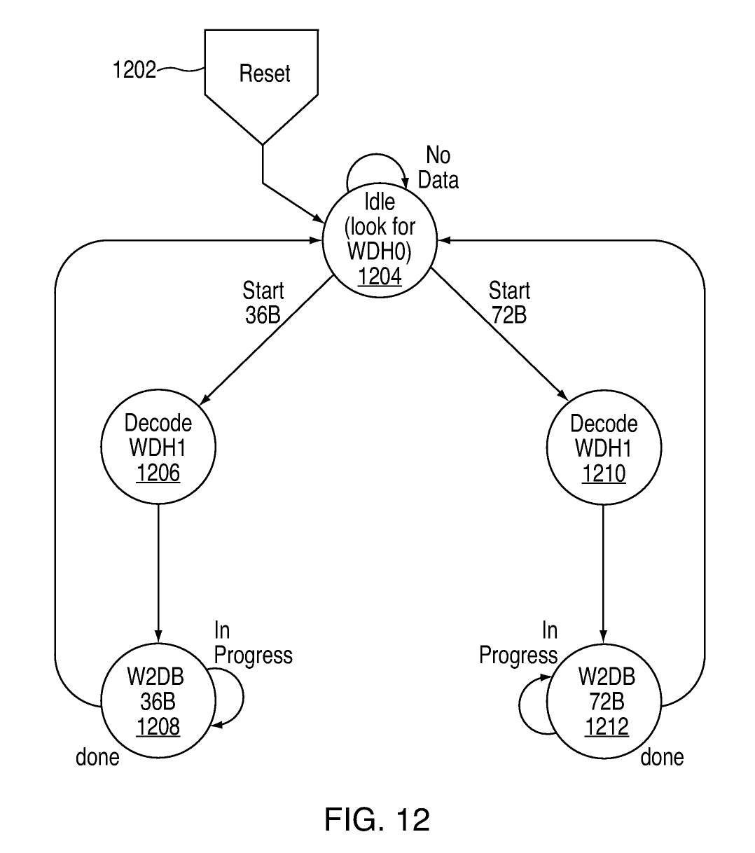

FIG. 11 depicts an example configuration register read data mapping that may be implemented by an exemplary embodiment. FIG. 11 depicts the mapping of hub device internal register bits onto each of the bits in the upstream read data frame.

FIG. 12 depicts a process flow for decoding write nibbles received in a downstream frame that may be implemented by exemplary embodiments of the present invention. In an exemplary embodiment, this processing is facilitated by the VFFPL 112 located on the hub devices. At block 1202, a reset to the system is received and processing continues at block 1204. In an exemplary embodiment, each data nibble received at the hub device is inspected at block 1204 to see if it contains one of the write data header 0 values depicted in FIG. 6; i.e., to see if it contains a non-zero value. As described previously, the location of the write nibbles in a frame is determined by one or more of the frame type field 516 and the block number (e.g., is it block 0 414, block 1 412, block 2 410 or block 3 408). When a non-zero value is found, block 1204 determines, based on the current write nibble (i.e., write data header 0), whether this is a 36 byte or 72 byte write data block.

If the length of the write data block is 36 bytes, then block 1206 is performed and the next write nibble is decoded (i.e., write data header 1) to determine the target hub device, target write data buffer, and target data port (which may be implied by the target write data buffer). Next, block 1208 is performed to read the next 36 bytes of data (the next 72 write nibbles) and to write it to the write data buffer specified by the write data header. Once this is complete, processing continues at block 1204.

If the length of the write data block is 72 bytes, then block 1210 is performed and the next write nibble is decoded (i.e., write data header 1) to determine the target hub device, target write data buffer, and target data port (which may be implied by the target write data buffer). Next, block 1212 is performed to read the next 72 bytes of data (the next 144 write nibbles) and to write it to the write data buffer specified by the write data header. Once this is complete, processing continues at block 1204.

The process depicted in FIG. 12 continues while the hub device is on-line and active. In this manner, write data may be packed into frames by the memory controller in a very efficient manner. Any available space in the data frames is being utilized to hold write data to be stored in a target write data buffer on a hub device. In addition, write nibble contents are used to initiate and identify the target of the write to data buffer commands, making them self-registering in that they do not use bits from the crc18 514 cmd28 518 to start the write to data buffer commands. When a write to data buffer command is in progress, it continues with no gaps in the write nibbles except for frame type 516, CRC 514 and cmd28 518 and 530 bits until complete. Between write to data buffer operations all “0000” write nibbles indicate that no new write to data buffer operation is beginning. Non-zero write data headers are used to register the beginning of a write to data buffer operation. New write to data buffer operations may begin any time after the previous one completes. If they begin immediately, following the previous write to data buffer operation, then there are no gaps between useful write nibbles (except for field type, CRC and command bits) even if the write to data buffer operation ends in mid-frame. Utilizing an exemplary embodiment of the present invention, nearly 100 percent of frame bits can be used for write data, command, and CRC bits (except the 2 bits of field type overhead). If commands are not needed, the frame bits can be used to deliver write data. This makes the approach very efficient and maximizes available write data bandwidth.

In an alternate exemplary embodiment, the use of non-zero write data headers is restricted to write data headers in the first write nibble of a frame (or alternatively, the first write nibble of a block) or immediately following the previous write to data buffer write nibbles. In this manner, only one write nibble in each frame is monitored to determine the presence of a write data header. This may lead to a saving in processing overhead.

Maintenance commands perform special operations within the hub device. Like mainline commands, they can be executed either by downstream memory channel commands or by the service interface using configured command sequences (CCSs). In an exemplary embodiment, each hub device maintenance command has four latches within a maintenance command status register. The first latch/bit is called the “start bit” and it is set to begin the maintenance command. This bit is automatically reset by the hub device (e.g., via hardware) as soon as the maintenance command actually begins. The second latch/bit is called the “in progress status bit”, it is active while the maintenance command is running. The third latch/bit is a “fail indicator bit” that is set when a maintenance command does not operate as expected. The fourth latch/bit is a “complete status bit” that is activated when the maintenance command finishes. The maintenance command status register can be accessed through the service interface or in-band using, for example, configuration register read/write commands (CFG Reg Rd/Wr commands).

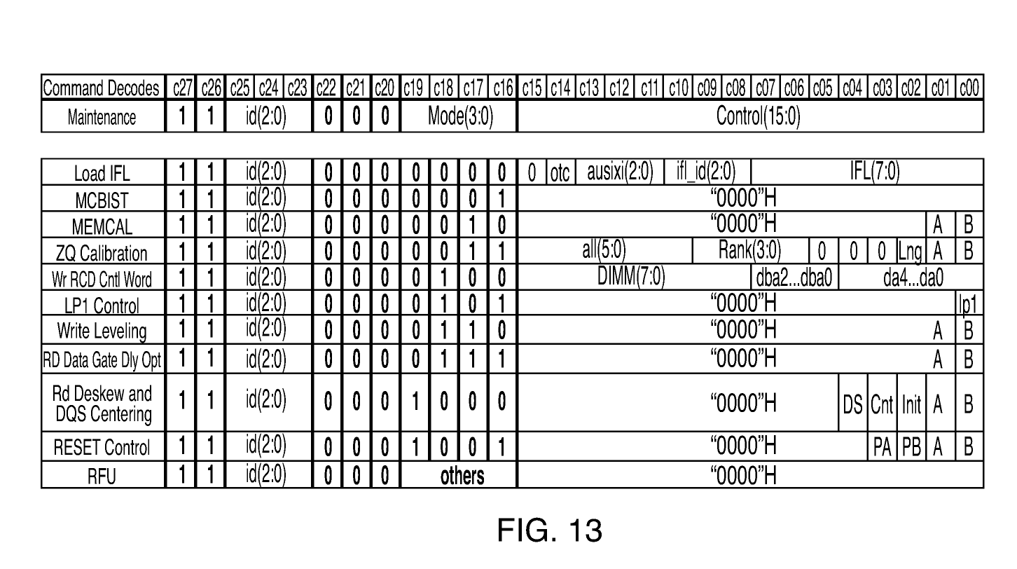

FIG. 13 depicts maintenance commands that may be implemented by an exemplary embodiment of the present invention. It includes command bit designations for the command decodes. In an exemplary embodiment, the command bits in cmd28 530 as depicted in block 1 508 in FIG. 5 are numbered consecutively with c00 in transfer 0/lane 0, c01 in transfer 1/lane 0, c02 in transfer 0/lane 2, c03 in transfer 0/lane 3, c04 in transfer 0/lane 1, c05 in transfer 1/lane 1, etc. ending in c27 in transfer 3/lane 6. The commands bits may be arranged similarly for cmd28 518 in block 0 510 in FIG. 5.

The load initial frame latency (IFL) command writes the hub device configuration register with the IFL value indicated in IFL(7:0). The IFL indicates the latency of the hub device indicated in the ifl_id(2:0) field. The IFL may be written into the hub device indicated in the id(2:0) field or to all hub devices in the memory channel by setting the id(2:0) field equal to “111” broadcast decode. Additive upstream transmitter latency of 0-7 blocks may be used to equalize differences between lock-step memory channels. The OTC field indicates the even or odd Tcac for the identified hub device. This value is used for RDBD in the 5:1 MC mode. In an exemplary embodiment, only one load IFL maintenance command may be issued in each memory channel downstream frame.

The memory card built-in self test (MCBIST) command launches the pre-configured MCBIST procedure. In an exemplary embodiment, before testing MCBIST will wake up (exit power down or exit self-timed refresh) any ranks it is configured to test. Upon completion, MCBIST will issue enter self refresh to the tested ranks.

The memory delay line calibration (MEMCAL) command kicks off the memory delay line calibration procedure. The system control software and/or memory controller place the SDRAMs in self-refresh before and during this command. The hub device guarantees that no glitches occur on memory RESET and CKE control signals. Calibration for delays on A and B memory ports may be performed separately or together using the ‘A’ and ‘B’ control bits.

The ZQ calibration command instructs the hub device to perform a long or short DDR3 ZQ calibration command to the selected memory rank(s). The all field can be used to calibrate multiple SDRAM ranks and the A and B fields are required to instruct the hub device to calibrate its SDRAM IOs. At the beginning of this maintenance operation, the hub device will wake up (exit power down or exit self refresh mode) all ranks to be calibrated. Next, the calibration steps are executed on each rank sequentially. Upon completion, the hub device places them into self refresh mode.

The write DDR3 registering clock driver control word command is used to write to the selected DDR3 registering clock driver (RCD) control registers.

The LP1 control command causes the hub device to enter the low power 1 mode when lp1=“1” and to exit when lp1=“0”.

The write leveling command causes the hub device to execute the write leveling procedure. Leveling on A and B memory ports may be performed separately or together using the ‘A’ and ‘B’ control bits. At the beginning of this maintenance operation, the hub device will wake up (exit power down mode or exit self refresh mode) all ranks to be calibrated. Next, the calibration steps are executed on each rank sequentially. Upon completion, the hub device places them into self refresh mode.

The read data gate delay optimization command causes the hub device to run the DDR3 read data gate delay optimization procedure. Optimization on A and B memory ports may be performed separately or together using the ‘A’ and ‘B’ control bits. At the beginning of this maintenance operation, the hub device will wake up (exit power down mode or exit self refresh mode) all ranks to be calibrated. Next, the calibration steps are executed on each rank sequentially. Upon completion, the hub device places them into self refresh mode.

The read data deskew and strobe centering command causes the hub device to run either the DDR3 read data strobe centering procedure (CNT=‘1’), or DDR3 read data deskew procedure (DS=‘1’) or both. Initial (Init=‘1’) or periodic calibration can be selected. Deskew and strobe centering for delays on A and B memory ports may be performed separately or together using the ‘A’ and ‘B’ control bits. At the beginning of this maintenance operation, the hub device will wake up (exit power down mode or exit self refresh mode) all ranks to be calibrated. Next, the calibration steps are executed on each rank sequentially. Upon completion, the hub device places them into self refresh mode.

The RESET control command directly manipulates the port A and port B SDRAM RESET signals. The values in the ‘A’ and ‘B’ fields will be applied, without inversion, to the negative active m[ab]_reset_n signals. This command is also used to reset the Port A and B DDR3 physical interface logic. A ‘1’ in the PA or PB fields will trigger the DDR3 PHY and DDR3 IO reset sequence which pulses the internal macro reset state. A ‘0’ in the PA and PB bits does not cause the DDR3 PHY internal reset sequence. This command uses ‘1’s in the PA, PB, A and B fields to exit the SDRAM RESET state and reset the SN DDR3 PHY and DDR3 IO calibration logic during the DDR3 reset and initialization procedure.

An additional maintenance command field is “Lng”. When set, this bit indicates the long ZQ calibration procedure should be executed, otherwise a short ZQ calibration is performed. Another maintenance command filed is “DIMM(7:0).” This field selects the pair of CS signals that will be activated during the RCD control word write operation. Maintenance command structures may be utilized for initialization, BIST, register programming, write leveling, read data gate delay optimization, read data de-skew and strobe centering, reset, etc. While the upstream bus is idle, the last hub device in the channel sends a consistent pattern, which is scrambled by the memory channel logic.

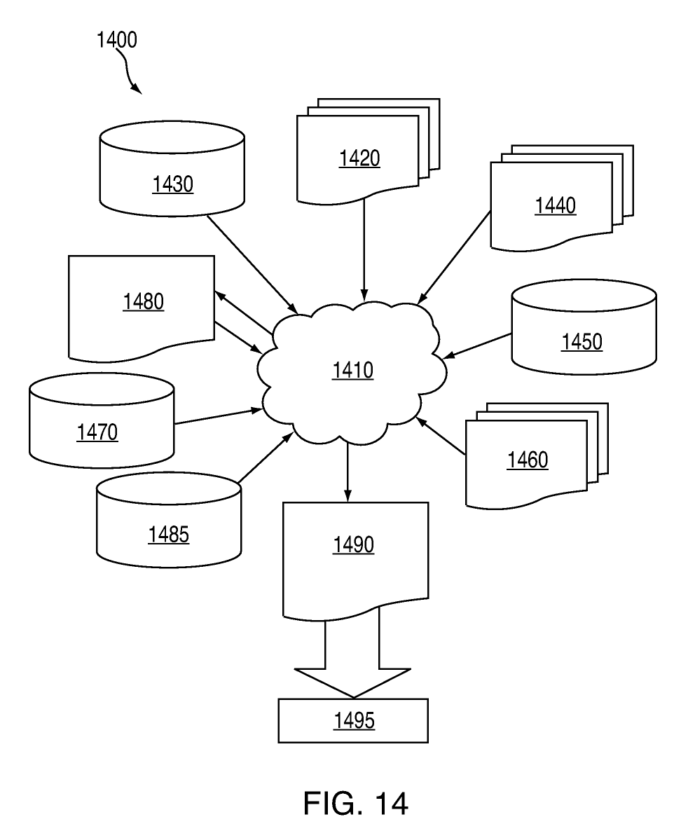

FIG. 14 shows a block diagram of an exemplary design flow 1400 used for example, in semiconductor IC logic design, simulation, test, layout, and manufacture. Design flow 1400 includes processes and mechanisms for processing design structures or devices to generate logically or otherwise functionally equivalent representations of the design structures and/or devices described above and shown in FIGS. 1-13. The design structures processed and/or generated by design flow 1400 may be encoded on machine readable transmission or storage media to include data and/or instructions that when executed or otherwise processed on a data processing system generate a logically, structurally, mechanically, or otherwise functionally equivalent representation of hardware components, circuits, devices, or systems. Design flow 1400 may vary depending on the type of representation being designed. For example, a design flow 1400 for building an application specific IC (ASIC) may differ from a design flow 1400 for designing a standard component or from a design flow 1400 for instantiating the design into a programmable array, for example a programmable gate array (PGA) or a field programmable gate array (FPGA) offered by Altera® Inc. or Xilinx® Inc.

FIG. 14 illustrates multiple such design structures including an input design structure 1420 that is preferably processed by a design process 1410. Design structure 1420 may be a logical simulation design structure generated and processed by design process 1410 to produce a logically equivalent functional representation of a hardware device. Design structure 1420 may also or alternatively comprise data and/or program instructions that when processed by design process 1410, generate a functional representation of the physical structure of a hardware device. Whether representing functional and/or structural design features, design structure 1420 may be generated using electronic computer-aided design (ECAD) such as implemented by a core developer/designer. When encoded on a machine-readable data transmission, gate array, or storage medium, design structure 1420 may be accessed and processed by one or more hardware and/or software modules within design process 1410 to simulate or otherwise functionally represent an electronic component, circuit, electronic or logic module, apparatus, device, or system such as those shown in FIGS. 1-13. As such, design structure 1420 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 1410 preferably employs and incorporates hardware and/or software modules for synthesizing, translating, or otherwise processing a design/simulation functional equivalent of the components, circuits, devices, or logic structures shown in FIGS. 1-13 to generate a netlist 1480 which may contain design structures such as design structure 1420. Netlist 1480 may comprise, for example, compiled or otherwise processed data structures representing a list of wires, discrete components, logic gates, control circuits, I/O devices, models, etc. that describes the connections to other elements and circuits in an integrated circuit design. Netlist 1480 may be synthesized using an iterative process in which netlist 1480 is resynthesized one or more times depending on design specifications and parameters for the device. As with other design structure types described herein, netlist 1480 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 1410 may include hardware and software modules for processing a variety of input data structure types including netlist 1480. Such data structure types may reside, for example, within library elements 1430 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 1440, characterization data 1450, verification data 1460, design rules 1470, and test data files 1485 which may include input test patterns, output test results, and other testing information. Design process 1410 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1410 without deviating from the scope and spirit of the invention. Design process 1410 may also include modules for performing standard circuit design processes such as timing analysis, verification, design rule checking, place and route operations, etc.

Design process 1410 employs and incorporates logic and physical design tools such as HDL compilers and simulation model build tools to process design structure 1420 together with some or all of the depicted supporting data structures along with any additional mechanical design or data (if applicable), to generate a second design structure 1490. Design structure 1490 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 1420, design structure 1490 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-12. In one embodiment, design structure 1490 may comprise a compiled, executable HDL simulation model that functionally simulates the devices shown in FIGS. 1-13.

Design structure 1490 may also employ a data format used for the exchange of layout data of integrated circuits and/or symbolic data format (e.g. information stored in a GDSII (GDS2), GL1, OASIS, map files, or any other suitable format for storing such design data structures). Design structure 1490 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1-13. Design structure 1490 may then proceed to a stage 1495 where, for example, design structure 1490: proceeds to tape-out, is released to manufacturing, is released to a mask house, is sent to another design house, is sent back to the customer, etc.

In an exemplary embodiment, hub devices may be connected to the memory controller through a multi-drop or point-to-point bus structure (which may further include a cascade connection to one or more additional hub devices). Memory access requests are transmitted by the memory controller through the bus structure (e.g., the memory bus) to the selected hub(s). In response to receiving the memory access requests, the hub device translates the memory access requests to control the memory devices to store write data from the hub device or to provide read data to the hub device. Read data is encoded into one or more communication packet(s) and transmitted through the memory bus(es) to the memory controller.

In alternate exemplary embodiments, the memory controller(s) may be integrated together with one or more processor chips and supporting logic, packaged in a discrete chip (commonly called a “northbridge” chip), included in a multi-chip carrier with the one or more processors and/or supporting logic, or packaged in various alternative forms that best match the application/environment. Any of these solutions may or may not employ one or more narrow/high speed links to connect to one or more hub chips and/or memory devices.

The memory modules may be implemented by a variety of technology including a DIMM, a single in-line memory module (SIMM) and/or other memory module or card structures. In general, a DIMM refers to a small circuit board which is comprised primarily of random access memory (RAM) integrated circuits or die on one or both sides with signal and/or power pins on both sides of the board. This can be contrasted to a SIMM which is a small circuit board or substrate composed primarily of RAM integrated circuits or die on one or both sides and single row of pins along one long edge. DIMMs have been constructed with pincounts ranging from 100 pins to over 300 pins. In exemplary embodiments described herein, memory modules may include two or more hub devices.

In exemplary embodiments, the memory bus is constructed using multi-drop connections to hub devices on the memory modules and/or using point-to-point connections. The downstream portion of the controller interface (or memory bus), referred to as the downstream bus, may include command, address, data and other operational, initialization or status information being sent to the hub devices on the memory modules. Each hub device may simply forward the information to the subsequent hub device(s) via bypass circuitry; receive, interpret and re-drive the information if it is determined to be targeting a downstream hub device; re-drive some or all of the information without first interpreting the information to determine the intended recipient; or perform a subset or combination of these options.

The upstream portion of the memory bus, referred to as the upstream bus, returns requested read data and/or error, status or other operational information, and this information may be forwarded to the subsequent hub devices via bypass circuitry; be received, interpreted and re-driven if it is determined to be targeting an upstream hub device and/or memory controller in the processor complex; be re-driven in part or in total without first interpreting the information to determine the intended recipient; or perform a subset or combination of these options.

In alternate exemplary embodiments, the point-to-point bus includes a switch or bypass mechanism which results in the bus information being directed to one of two or more possible hub devices during downstream communication (communication passing from the memory controller to a hub device on a memory module), as well as directing upstream information (communication from a hub device on a memory module to the memory controller), often by way of one or more upstream hub devices. Further embodiments include the use of continuity modules, such as those recognized in the art, which, for example, can be placed between the memory controller and a first populated hub device (i.e., a hub device that is in communication with one or more memory devices), in a cascade interconnect memory system, such that any intermediate hub device positions between the memory controller and the first populated hub device include a means by which information passing between the memory controller and the first populated hub device can be received even if the one or more intermediate hub device position(s) do not include a hub device. The continuity module(s) may be installed in any module position(s), subject to any bus restrictions, including the first position (closest to the main memory controller, the last position (prior to any included termination) or any intermediate position(s). The use of continuity modules may be especially beneficial in a multi-module cascade interconnect bus structure, where an intermediate hub device on a memory module is removed and replaced by a continuity module, such that the system continues to operate after the removal of the intermediate hub device. In more common embodiments, the continuity module(s) would include either interconnect wires to transfer all required signals from the input(s) to the corresponding output(s), or be re-driven through a repeater device. The continuity module(s) might further include a non-volatile storage device (such as an EEPROM), but would not include main memory storage devices.

In exemplary embodiments, the memory system includes one or more hub devices on one or more memory modules connected to the memory controller via a cascade interconnect memory bus, however other memory structures may be implemented such as a point-to-point bus, a multi-drop memory bus or a shared bus. Depending on the signaling methods used, the target operating frequencies, space, power, cost, and other constraints, various alternate bus structures may be considered. A point-to-point bus may provide the optimal performance in systems produced with electrical interconnections, due to the reduced signal degradation that may occur as compared to bus structures having branched signal lines, switch devices, or stubs. However, when used in systems requiring communication with multiple devices or subsystems, this method will often result in significant added component cost and increased system power, and may reduce the potential memory density due to the need for intermediate buffering and/or re-drive.

Although not shown in the Figures, the memory modules or hub devices may also include a separate bus, such as a ‘presence detect’ bus, an I2C bus and/or an SMBus which is used for one or more purposes including the determination of the hub device an/or memory module attributes (generally after power-up), the reporting of fault or status information to the system, the configuration of the hub device(s) and/or memory subsystem(s) after power-up or during normal operation or other purposes. Depending on the bus characteristics, this bus might also provide a means by which the valid completion of operations could be reported by the hub devices and/or memory module(s) to the memory controller(s), or the identification of failures occurring during the execution of the main memory controller requests.

Performances similar to those obtained from point-to-point bus structures can be obtained by adding switch devices. These and other solutions offer increased memory packaging density at lower power, while retaining many of the characteristics of a point-to-point bus. Multi-drop busses provide an alternate solution, albeit often limited to a lower operating frequency, but at a cost/performance point that may be advantageous for many applications. Optical bus solutions permit significantly increased frequency and bandwidth potential, either in point-to-point or multi-drop applications, but may incur cost and space impacts.

As used herein the term “buffer” or “buffer device” refers to a temporary storage unit (as in a computer), especially one that accepts information at one rate and delivers it another. In exemplary embodiments, a buffer is an electronic device that provides compatibility between two signals (e.g., changing voltage levels or current capability). The term “hub” is sometimes used interchangeably with the term “buffer.” A hub is a device containing multiple ports that is connected to several other devices. A port is a portion of an interface that serves a congruent I/O functionality (e.g., a port may be utilized for sending and receiving data, address, and control information over one of the point-to-point links, or busses). A hub may be a central device that connects several systems, subsystems, or networks together. A passive hub may simply forward messages, while an active hub, or repeater, amplifies and refreshes the stream of data which otherwise would deteriorate over a distance. The term hub device, as used herein, refers to a hub chip that includes logic (hardware and/or software) for performing memory functions.

Also as used herein, the term “bus” refers to one of the sets of conductors (e.g., wires, and printed circuit board traces or connections in an integrated circuit) connecting two or more functional units in a computer. The data bus, address bus and control signals, despite their names, constitute a single bus since each are often useless without the others. A bus may include a plurality of signal lines, each signal line having two or more connection points, that form a main transmission path that electrically connects two or more transceivers, transmitters and/or receivers. The term “bus” is contrasted with the term “channel” which is often used to describe the function of a “port” as related to a memory controller in a memory system, and which may include one or more busses or sets of busses. The term “channel” as used herein refers to a port on a memory controller. Note that this term is often used in conjunction with I/O or other peripheral equipment, however the term channel has been adopted by some to describe the interface between a processor or memory controller and one of one or more memory subsystem(s).

Further, as used herein, the term “daisy chain” refers to a bus wiring structure in which, for example, device A is wired to device B, device B is wired to device C, etc. The last device is typically wired to a resistor or terminator. All devices may receive identical signals or, in contrast to a simple bus, each device may modify one or more signals before passing them on. A “cascade” or cascade interconnect’ as used herein refers to a succession of stages or units or a collection of interconnected networking devices, typically hubs, in which the hubs operate as a logical repeater, further permitting merging data to be concentrated into the existing data stream. Also as used herein, the term “point-to-point” bus and/or link refer to one or a plurality of signal lines that may each include one or more terminators. In a point-to-point bus and/or link, each signal line has two transceiver connection points, with each transceiver connection point coupled to transmitter circuitry, receiver circuitry or transceiver circuitry. A signal line refers to one or more electrical conductors or optical carriers, generally configured as a single carrier or as two or more carriers, in a twisted, parallel, or concentric arrangement, used to transport at least one logical signal.

Memory devices are generally defined as integrated circuits that are composed primarily of memory (storage) cells, such as DRAMs (Dynamic Random Access Memories), SRAMs (Static Random Access Memories), FeRAMs (Ferro-Electric RAMs), MRAMs (Magnetic Random Access Memories), Flash Memory and other forms of random access and related memories that store information in the form of electrical, optical, magnetic, biological or other means. Dynamic memory device types may include asynchronous memory devices such as FPM DRAMs (Fast Page Mode Dynamic Random Access Memories), EDO (Extended Data Out) DRAMs, BEDO (Burst EDO) DRAMs, SDR (Single Data Rate) Synchronous DRAMs, DDR (Double Data Rate) Synchronous DRAMs or any of the expected follow-on devices such as DDR2, DDR3, DDR4 and related technologies such as Graphics RAMs, Video RAMs, LP RAM (Low Power DRAMs) which are often based on the fundamental functions, features and/or interfaces found on related DRAMs.

Memory devices may be utilized in the form of chips (die) and/or single or multi-chip packages of various types and configurations. In multi-chip packages, the memory devices may be packaged with other device types such as other memory devices, logic chips, analog devices and programmable devices, and may also include passive devices such as resistors, capacitors and inductors. These packages may include an integrated heat sink or other cooling enhancements, which may be further attached to the immediate carrier or another nearby carrier or heat removal system.

Module support devices (such as buffers, hubs, hub logic chips, registers, PLL's, DLL's, non-volatile memory, etc) may be comprised of multiple separate chips and/or components, may be combined as multiple separate chips onto one or more substrates, may be combined onto a single package or even integrated onto a single device—based on technology, power, space, cost and other tradeoffs. In addition, one or more of the various passive devices such as resistors, capacitors may be integrated into the support chip packages, or into the substrate, board or raw card itself, based on technology, power, space, cost and other tradeoffs. These packages may include an integrated heat sink or other cooling enhancements, which may be further attached to the immediate carrier or another nearby carrier or heat removal system.

Memory devices, hubs, buffers, registers, clock devices, passives and other memory support devices and/or components may be attached to the memory subsystem and/or hub device via various methods including soldered interconnects, conductive adhesives, socket structures, pressure contacts and other methods which enable communication between the two or more devices via electrical, optical or alternate means.

The one or more memory modules (or memory subsystems) and/or hub devices may be electrically connected to the memory system, processor complex, computer system or other system environment via one or more methods such as soldered interconnects, connectors, pressure contacts, conductive adhesives, optical interconnects and other communication and power delivery methods. Connector systems may include mating connectors (male/female), conductive contacts and/or pins on one carrier mating with a male or female connector, optical connections, pressure contacts (often in conjunction with a retaining mechanism) and/or one or more of various other communication and power delivery methods. The interconnection(s) may be disposed along one or more edges of the memory assembly and/or placed a distance from an edge of the memory subsystem depending on such application requirements as ease-of-upgrade/repair, available space/volume, heat transfer, component size and shape and other related physical, electrical, optical, visual/physical access, etc. Electrical interconnections on a memory module are often referred to as contacts, or pins, or tabs. Electrical interconnections on a connector are often referred to as contacts or pins.

As used herein, the term memory subsystem refers to, but is not limited to: one or more memory devices; one or more memory devices and associated interface and/or timing/control circuitry; and/or one or more memory devices in conjunction with a memory buffer, hub device, and/or switch. The term memory subsystem may also refer to one or more memory devices, in addition to any associated interface and/or timing/control circuitry and/or a memory buffer, hub device or switch, assembled into a substrate, a card, a module or related assembly, which may also include a connector or similar means of electrically attaching the memory subsystem with other circuitry. The memory modules described herein may also be referred to as memory subsystems because they include one or more memory devices and hub devices

Additional functions that may reside local to the memory subsystem and/or hub device include write and/or read buffers, one or more levels of memory cache, local pre-fetch logic, data encryption/decryption, compression/decompression, protocol translation, command prioritization logic, voltage and/or level translation, error detection and/or correction circuitry, data scrubbing, local power management circuitry and/or reporting, operational and/or status registers, initialization circuitry, performance monitoring and/or control, one or more co-processors, search engine(s) and other functions that may have previously resided in other memory subsystems. By placing a function local to the memory subsystem, added performance may be obtained as related to the specific function, often while making use of unused circuits within the subsystem.

Memory subsystem support device(s) may be directly attached to the same substrate or assembly onto which the memory device(s) are attached, or may be mounted to a separate interposer or substrate also produced using one or more of various plastic, silicon, ceramic or other materials which include electrical, optical or other communication paths to functionally interconnect the support device(s) to the memory device(s) and/or to other elements of the memory or computer system.

Information transfers (e.g. packets) along a bus, channel, link or other naming convention applied to an interconnection method may be completed using one or more of many signaling options. These signaling options may include such methods as single-ended, differential, optical or other approaches, with electrical signaling further including such methods as voltage or current signaling using either single or multi-level approaches. Signals may also be modulated using such methods as time or frequency, non-return to zero, phase shift keying, amplitude modulation and others. Voltage levels are expected to continue to decrease, with 1.5V, 1.2V, 1V and lower signal voltages expected consistent with (but often independent of) the reduced power supply voltages required for the operation of the associated integrated circuits themselves.

One or more clocking methods may be utilized within the memory subsystem and the memory system itself, including global clocking, source-synchronous clocking, encoded clocking or combinations of these and other methods. The clock signaling may be identical to that of the signal lines themselves, or may utilize one of the listed or alternate methods that is more conducive to the planned clock frequency(ies), and the number of clocks planned within the various subsystems. A single clock may be associated with all communication to and from the memory, as well as all clocked functions within the memory subsystem, or multiple clocks may be sourced using one or more methods such as those described earlier. When multiple clocks are used, the functions within the memory subsystem may be associated with a clock that is uniquely sourced to the subsystem, or may be based on a clock that is derived from the clock related to the information being transferred to and from the memory subsystem (such as that associated with an encoded clock). Alternately, a unique clock may be used for the information transferred to the memory subsystem, and a separate clock for information sourced from one (or more) of the memory subsystems. The clocks themselves may operate at the same or frequency multiple of the communication or functional frequency, and may be edge-aligned, center-aligned or placed in an alternate timing position relative to the data, command or address information.

Information passing to the memory subsystem(s) will generally be composed of address, command and data, as well as other signals generally associated with requesting or reporting status or error conditions, resetting the memory, completing memory or logic initialization and other functional, configuration or related information. Information passing from the memory subsystem(s) may include any or all of the information passing to the memory subsystem(s), however generally will not include address and command information. This information may be communicated using communication methods that may be consistent with normal memory device interface specifications (generally parallel in nature), the information may be encoded into a ‘packet’ structure, which may be consistent with future memory interfaces or simply developed to increase communication bandwidth and/or enable the subsystem to operate independently of the memory technology by converting the received information into the format required by the receiving device(s).

Initialization of the memory subsystem may be completed via one or more methods, based on the available interface busses, the desired initialization speed, available space, cost/complexity objectives, subsystem interconnect structures, the use of alternate processors (such as a service processor) which may be used for this and other purposes, etc. In one embodiment, the high speed bus may be used to complete the initialization of the memory subsystem(s), generally by first completing a training process to establish reliable communication, then by interrogation of the attribute or ‘presence detect’ data associated with the various components and/or characteristics associated with that subsystem, and ultimately by programming the appropriate devices with information associated with the intended operation within that system. In a cascaded system, communication with the first memory subsystem would generally be established, followed by subsequent (downstream) subsystems in the sequence consistent with their position along the cascade interconnect bus.

A second initialization method would include one in which the high speed bus is operated at one frequency during the initialization process, then at a second (and generally higher) frequency during the normal operation. In this embodiment, it may be possible to initiate communication with all of the memory subsystems on the cascade interconnect bus prior to completing the interrogation and/or programming of each subsystem, due to the increased timing margins associated with the lower frequency operation.

A third initialization method might include operation of the cascade interconnect bus at the normal operational frequency(ies), while increasing the number of cycles associated with each address, command and/or data transfer. In one embodiment, a packet containing all or a portion of the address, command and/or data information might be transferred in one clock cycle during normal operation, but the same amount and/or type of information might be transferred over two, three or more cycles during initialization. This initialization process would therefore be using a form of ‘slow’ commands, rather than ‘normal’ commands, and this mode might be automatically entered at some point after power-up and/or re-start by each of the subsystems and the memory controller by way of POR (power-on-reset) logic included in each of these subsystems.

A fourth initialization method might utilize a distinct bus, such as a presence detect bus (such as the one defined in U.S. Pat. No. 5,513,135 to Dell et al., of common assignment herewith), an I2C bus (such as defined in published JEDEC standards such as the 168 Pin DIMM family in publication 21-C revision 7R8) and/or the SMBUS, which has been widely utilized and documented in computer systems using such memory modules. This bus might be connected to one or more modules within a memory system in a daisy chain/cascade interconnect, multi-drop or alternate structure, providing an independent means of interrogating memory subsystems, programming each of the one or more memory subsystems to operate within the overall system environment, and adjusting the operational characteristics at other times during the normal system operation based on performance, thermal, configuration or other changes desired or detected in the system environment.

Other methods for initialization can also be used, in conjunction with or independent of those listed. The use of a separate bus, such as described in the fourth embodiment above, also offers the advantage of providing an independent means for both initialization and uses other than initialization, such as described in U.S. Pat. No. 6,381,685 to Dell et al., of common assignment herewith, including changes to the subsystem operational characteristics on-the-fly and for the reporting of and response to operational subsystem information such as utilization, temperature data, failure information or other purposes.

With improvements in lithography, better process controls, the use of materials with lower resistance, increased field sizes and other semiconductor processing improvements, increased device circuit density (often in conjunction with increased die sizes) will help facilitate increased function on integrated devices as well as the integration of functions previously implemented on separate devices. This integration will serve to improve overall performance of the intended function, as well as promote increased storage density, reduced power, reduced space requirements, lower cost and other manufacturer and customer benefits. This integration is a natural evolutionary process, and may result in the need for structural changes to the fundamental building blocks associated with systems.

The integrity of the communication path, the data storage contents and all functional operations associated with each element of a memory system or subsystem can be assured, to a high degree, with the use of one or more fault detection and/or correction methods. Any or all of the various elements may include error detection and/or correction methods such as CRC (Cyclic Redundancy Code), EDC (Error Detection and Correction), parity or other encoding/decoding methods suited for this purpose. Further reliability enhancements may include operation re-try (to overcome intermittent faults such as those associated with the transfer of information), the use of one or more alternate or replacement communication paths to replace failing paths and/or lines, complement-re-complement techniques or alternate methods used in computer, communication and related systems.

The use of bus termination, on busses as simple as point-to-point links or as complex as multi-drop structures, is becoming more common consistent with increased performance demands. A wide variety of termination methods can be identified and/or considered, and include the use of such devices as resistors, capacitors, inductors or any combination thereof, with these devices connected between the signal line and a power supply voltage or ground, a termination voltage or another signal. The termination device(s) may be part of a passive or active termination structure, and may reside in one or more positions along one or more of the signal lines, and/or as part of the transmitter and/or receiving device(s). The terminator may be selected to match the impedance of the transmission line, or selected via an alternate approach to maximize the useable frequency, operating margins and related attributes within the cost, space, power and other constraints.

Technical effects and benefits include enhancing bus efficiency and utilization in a memory system of a computer system. For example, utilizing a variable frame format allows a frame to be populated based on the type of data being transmitted and thus, may lead to more efficient use of bits in the frame because a higher percentage of the bits will have usable data. In addition, the ability to support self-registering write commands may lead to an improvement in store bandwidth.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof In addition, it will be understood that the use of the terms first, second, etc. do not denote any order or importance, but rather the terms first, second, etc. are used to distinguish one element from another.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A memory hub device comprising:
a first bus interface for communicating with a high-speed bus; and
frame decode logic for translating variable format frames received via the first bus interface into memory device commands and data, the translating including identifying write data headers and associated write data for self-registering write to data buffer commands.

2. The memory hub device of claim 1 wherein the frames include write data bits and the identifying includes:
determining placement of write data bits in the frames;
monitoring contents of the write data bits;
identifying a write data header for a self-registering write to data buffer command in the write data bits, the write data header specifying a length of associated write data; and
identifying the associated write data in the write data bits, the identifying responsive to the write data header.

3. The memory hub device of claim 2 wherein the frame includes a frame type field and the determining placement is responsive to the frame type field.

4. The memory hub device of claim 2 wherein the frames include write data bits and associated write data for a self-registering write to data buffer command is located in write data bits that immediately follow the write data header for the self-registering write data to buffer command.

5. The memory hub device of claim 2 wherein the length of the write data header is one byte.

6. The memory hub device of claim 2 wherein the length of the associated write data is thirty-six bytes.

7. The memory hub device of claim 2 wherein the length of the associated write data is seventy-two bytes.

8. The memory hub device of claim 1 wherein each frame includes two or more blocks and one or both of a write data header and associated write data for at least one of the self-registering write to data buffer commands span at least two blocks.

9. The memory hub device of claim 1 wherein one or both of a write data header and associated write data for at least one of the self-registering write to data buffer commands span at least two or more frames.

10. The memory hub device of claim 1 further comprising a plurality of write data buffers, wherein the write data headers include target hub device identifiers, and the hub device writes associated write data for a self-registering write to data buffer command to one of the write data buffers in response to the hub device being identified as the target hub device.

11. The memory hub device of claim 1 further comprising a plurality of write data buffers, wherein the write data headers include target hub device identifiers and target write data buffer identifiers, and the hub device writes associated write data for a self-registering write to data buffer command to one of the write data buffers in response to the hub device being identified as the target hub device and to the write data buffer being identified as the target write data buffer.

12. The memory hub device of claim 1 wherein the variable format frames include CRC bits, frame type indicator bits, and one of write data bits, write data bits and one command, and write data bits and two commands based on contents of the frame type indicator bits.

13. The memory hub device of claim 1 wherein the high-speed bus includes a plurality of wires, each wire capable of carrying both data and commands.

14. A method for providing a variable frame format protocol in a cascade interconnected memory system, the method comprising:
receiving frames of varying formats on a high-speed bus, the receiving at a hub device in a cascade interconnected memory system, each frame including a frame type indicator and one or more write data bits;
determining placement of the write data bits in the frames, the determining responsive to the frame type indicator;
monitoring contents of the write data bits;
identifying a write data header for a self-registering write to data buffer command in the write data bits, the write data header specifying a length of associated write data and a target hub device identifier;
identifying the associated write data in the write data bits, the identifying responsive to the write data header; and
writing the associated write data to a write data buffer at the hub device in response to the hub device being identified as the target hub device.

15. The method of claim 14 wherein the associated write data is located in write data bits that immediately follow the write data header.

16. The method of claim 14 wherein each frame includes two or more blocks and one or both of the write data header and the associated write data for the self-registering write to data buffer command span at least one of two or more blocks and two or more frames.

17. A memory controller comprising:
a first bus interface for communicating with one or more hub devices in a cascade interconnect memory system via a high-speed bus; and
frame encoding logic for generating variable format frames for transmission to the hub devices, the generated frames comprising:
frame type indicators for specifying locations of write data bits in the frames; and
write data headers and associated write data for self-registering write to data buffer commands, the write data header and associated write located in the write data bits.

18. The memory controller of claim 17 wherein each frame includes two or more blocks and one or both of a write data header and associated write data for at least one of the self-registering write to data buffer commands span at least two blocks.

19. The memory controller of claim 17 wherein one or both of a write data header and associated write data for at least one of the self-registering write to data buffer commands span at least two or more frames.

20. A design structure tangibly embodied in a machine readable medium for designing, manufacturing, or testing an integrated circuit, the design structure comprising:
a first bus interface for communicating with a high-speed bus; and
frame decode logic for translating variable format frames received via the first bus interface into memory device commands and data, the translating including identifying write data headers and associated write data for self-registering write to data buffer commands.
